(19) United States
(12) Patent Application Publication
(10) Pub. No.: US 2026/0318390 A1
(43) Pub. Date: Oct. 15, 2026

(54) ROLLER SCREW DRIVE

(71) Applicant: Schaeffler Technologies AG & Co. KG, Herzogenaurach (DE)

(72) Inventors: Hans-Joachim Troesch, Hermeskeil (DE); Patrick Daniel, Kirkel (DE); Martin Menges, Homburg (DE); Peter Keller, Bruchmühlbach-Miesau (DE); Sebastian Weis, Brücken (DE)

(73) Assignee: Schaeffler Technologies AG & Co. KG, Herzogenaurach (DE)

(21) Appl. No.: 19/483,862

(22) PCT Filed: Apr. 18, 2024
(86) PCT No.: PCT/DE2024/100334

§ 371 Date: Nov. 12, 2025

(30) Foreign Application Priority Data
May 17, 2023 (DE) 102023112967.8

(51) Int. Cl. F16H 25/22

(52) U.S. Cl. CPC F16H 25/2252; F16H 2025/228

(57) ABSTRACT

A roller screw drive comprises a cage that guides a plurality of rolling bodies wherein lubricant-conveying contours are formed on the end face of the cage and are each adjoined by a respective longitudinal groove which is located in a web by means of which two pockets of the cage, which are provided to receive a respective rolling body are separated from each other.

### CROSS-REFERENCE TO RELATED APPLICATIONS

This application is a U.S. national stage application under 35 U.S.C. § 371 that claims the benefit of priority under 35 U.S.C. § 365 of International Patent Application No. PCT/DE2024/100334, filed on Apr. 18, 2024, designating the United States of America, which in turn claims the benefit of priority under 35 U.S.C. § § 119, 365 of German Patent Application No. 102023112967.8, filed on May 17, 2023, the contents of which are relied upon and incorporated herein by reference in their entirety.

### FIELD OF THE DISCLOSURE

The disclosure relates to a roller screw drive, which may be installed, for example, in an electromechanical actuator.

### BACKGROUND OF THE DISCLOSURE

A roller screw drive of the type in question is known, for example, from DE 10 2011 075 950 A1. This is a planetary roller screw drive which has planetary rollers that are guided by a rigid cage.

A planetary roller screw drive described in WO 2011/113724 A1 has planets that are mounted in centering discs. Each centering disc has bores which are arranged distributed over the circumference and correspond to the number of planets, in which bores the pins of the planets engage.

A threaded roller screw drive disclosed in DE 10 2021 202 539 A1, like the devices according to the documents DE 10 2011 075 950 A1 and WO 2011/113724 A1, comprises a plurality of rollers, i.e., planets, which have a pitchless profile, i.e., are provided with non-helical grooves. In the case of DE 10 2021 202 539 A1, a cage is configured to press a spindle of the threaded roller screw drive into a radially centered position in a nut.

A threaded roller screw drive described in EP 0 229 744 A1 comprises a plurality of rollers, which in this case are referred to as satellite rollers. The rollers are mounted in bearing discs connected to a cage by means of driver supports, with there being longitudinal play of the rollers in the cage.

A possible design of an actuator that works with a planetary roller screw drive is shown in WO 2015/081951 A1. In this case, planetary roller carriers, in which planetary rollers are positioned, are supported in a rotationally fixed manner.

DE 10 2011 003 694 A1 describes a nut ring for a planetary screw drive or threaded roller screw drive. The nut ring has a plurality of radially inwardly projecting circumferential engagement contours, which are formed by individual rings arranged concentrically one behind the other in a sleeve enclosing them.

### SUMMARY OF THE DISCLOSURE

The disclosure is based on providing a roller screw drive which is further developed with respect to the cited prior art, is easy to manufacture and which is characterized in particular by good lubrication properties.

This object is achieved according to the disclosure by a roller screw drive having a cage in a known basic concept in which a plurality of rolling bodies, i.e., rollers, are guided. Lubricant-conveying contours are formed on at least one end face of the cage of the roller screw drive, each of which lubricant-conveying contours is adjoined by a longitudinal groove located in a ridge that separates two pockets of the cage from one another which are each provided to receive a rolling body.

The lubricant-conveying contours, together with the longitudinal grooves, ensure the distribution and transport of the lubricant, in particular lubricating grease, in the roller screw drive. In particular, there is at least one longitudinal groove on the inner circumferential surface of the cage. Lubricant is thus fed to the effective regions of the rollers, which supplies both the threaded spindle and the spindle nut of the roller screw drive with lubricant.

According to various possible embodiments, the lubricant-conveying contours are each formed by a ramp which starts from the end face of the cage, comprising a cylindrical basic shape, and which extends to the longitudinal groove and an impact surface which is arranged on the side of the longitudinal groove opposite the ramp and which is oriented at least approximately at a right angle to the end face. The lubricant-conveying contours thus fulfill a so-called excavator function, which in simple terms means “excavating” lubricant from an end-face end region of the roller screw drive towards the center of the interior of the roller screw drive. This excavator function also reduces forces in the end position region of the roller screw drive, since compression of the lubricant is reduced. Optionally, the longitudinal groove has a groove extension which borders its bottom, starts from the second partial surface and runs in a longitudinal direction of the groove.

In order to achieve the same lubrication effect for both anti-clockwise and clockwise rotation, different lubricant-conveying contours can be optimized for anti-clockwise rotation of the cage in one case and for clockwise rotation in the other case. In particular, two circumferentially adjacent lubricant-conveying contours can be designed to be mirror-symmetrical with respect to one another. There can be plurality of such pairs of lubricant-conveying contours, effective according to the direction of rotation, at the cage end face. The number of lubricant-conveying contours arranged on one and the same end face can be less than the number of pockets of the cage or can correspond to the number of pockets and thus also to the number of rolling bodies.

In order to direct lubricant, which flows through the longitudinal groove during operation of the roller screw drive, i.e., in an axial direction of the roller screw drive, at least partially in a radial direction of the cage, the cage ridge separating two pockets of the cage from one another and/or the longitudinal groove running in said ridge can be interrupted by at least one contour. Such a contour can, for example, be a short radial ridge that interrupts the longitudinal groove approximately centrally between the two end faces of the cage. Additionally or alternatively, bores can start from the groove base of the longitudinal groove and end at the outer circumferential surface of the cage, i.e., on the outside of the cage ridge.

The roller screw drive can be designed in particular as a planetary roller screw drive. Either the threaded spindle or the nut of the screw drive can be designed as a driving, rotating element, and the other element can be designed as a linearly adjustable output element. It is also possible to drive the cage that guides the rolling bodies and thus use the screw drive as an equal-pitch planetary roller screw drive. In this context, reference is made by way of example to document DE 10 2021 100 275 A1.

A wide variety of materials, in particular plastics and metals, such as steel or non-ferrous metal alloys, are suitable for manufacturing the cage of the roller screw drive. In principle, known primary shaping and forming or machining processes can be used to manufacture the cage. In many embodiments, the cage is a one-piece element. A multi-part design of the cage is also possible. In both cases, the cage as a whole or in individual surface portions can be provided with a friction-and/or wear-reducing coating.

If the cage is designed as the driving element of the roller screw drive, torque-transmitting contours, in particular in the form of a tooth system, can be formed either by the cage directly or by a separate machine element that is connected to the cage in a rotationally fixed manner.

If the roller screw drive is a planetary roller screw drive, the rolling bodies, i.e., rollers, of the screw drive have a pitchless profile. Likewise, the inner circumferential surface of the nut in which the rolling bodies roll has a pitchless profile, i.e., in the form of notches. As the name suggests, only the threaded spindle brought into contact with the rollers has a thread, which can be single-start or multi-start.

Threaded roller screw drives, which can also be considered as designs for the roller screw drive according to the application, differ from planetary roller screw drives, among other things, in that each of the components of spindle, rollers and nut has a thread. Particularly in the case of the roller screw drive designed as a threaded roller screw drive, the nut of the screw drive is also referred to a nut ring. In numerous design variants of threaded roller screw drives, the planets have tooth systems at both ends, which interact with a tooth system in the nut in the manner of a spur gear. However, if the aforementioned tooth systems of the rollers mesh with a tooth system provided by the spindle, this is called an inverse threaded roller screw drive. Such an inverse threaded roller screw drive also represents a possible embodiment of the roller screw drive.

The roller screw drive can be used in a vehicle as well as in a stationary industrial system, for example in an industrial robot or in a machine tool.

### BRIEF DESCRIPTION OF THE DRAWINGS

FIG. 1 is a perspective view of a section of a cage of a roller screw drive in a perspective view;

FIG. 2 is a schematic representation of a roller screw drive comprising the cage according to FIG. 1;

FIG. 3 shows a detail of the cage according to FIG. 1; and

FIG. 4 shows a modified cage for a roller screw drive.

### DETAILED DESCRIPTION

Unless otherwise stated, the following explanations relate to the exemplary embodiments presented. Parts or contours that correspond to each other or have basically the same effect are marked with the same reference signs in all the figures.

The roller screw drive 1 is suitable, for example, for use in an electromechanical actuator, not shown in detail. The roller screw drive 1, namely planetary roller screw drive, comprises a threaded spindle 2 and a nut 3, wherein, for example, the nut 3, which is also referred to as a nut ring, can be used as a drive element and the threaded spindle 2 can be used as a non-rotatably displaceable output element of the roller screw drive 1. Conversely, it is also possible to drive the threaded spindle 2 rotationally and to use the nut 3 as a linearly adjustable output element of the roller screw drive 1.

Rollers 4 are arranged as rolling bodies of the roller screw drive 1 between the threaded spindle 2 and the nut 3. The thread of the threaded spindle 2 is denoted by 21, and the thread of the nut 3 is denoted by 22. In a manner not shown, the nut 3 can be constructed in several parts, and in particular individual nut parts can be braced against one another in order to operate the roller screw drive 1 with bias. The threads 21, 22 of the input and output elements 2, 3 interact with pitchless, notch-like profiles 23 of the rollers 4.

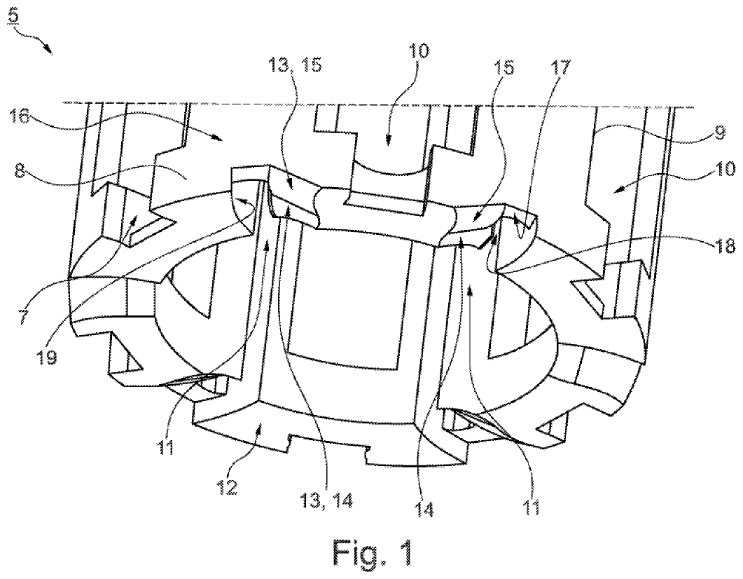

The rollers 4 are guided in a cage 5 having a cylindrical basic shape, with roller pins 6 of the rollers 4 being guided in recesses 7 of the cage 5. The recesses 7 are located on a cage ring denoted by 8, which is concentric with the central axis of the roller screw drive 1 and from which cage ridges 9 start, which are oriented in an axial direction of the cage 5 and thus of the entire roller screw drive 1 and which are connected in one piece to a further cage ring 8, not visible in FIGS. 1 to 3. Between each two circumferentially adjacent cage ridges 9, which are also referred to as ridges for short, a pocket 10 is formed for receiving a roller 4. The end face of the cage 5 is denoted by 12 and the outer circumferential surface of the cage 5 is denoted by 16.

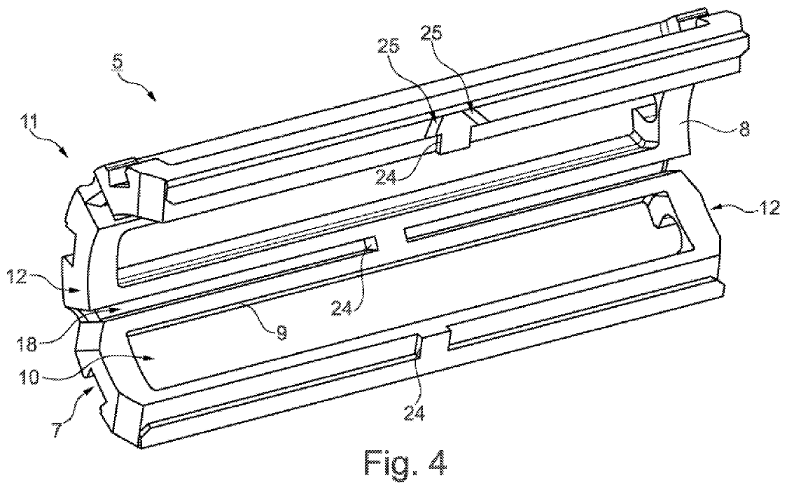

As can be seen from FIGS. 1 and 3, lubricant-conveying contours 11 are formed at the end face 12. Each lubricant-conveying contour 11 has a ramp 13 which is inclined relative to the end face 12 and comprises two mutually distinguishable partial surfaces 14, 15. In this case, an outer partial surface 15 borders on the outer circumferential surface 16, whereas an inner partial surface 14 borders on the inner circumferential surface of the cage 5.

The two partial surfaces 14, 15 differ from one another with regard to their length measured in a circumferential direction of the cage ring 8 and with regard to their inclination relative to a plane applied to the end face 12 and run, starting from the end face 12, inwards, i.e., in the direction of the opposite end face 12 of the cage 5. This means that the inwardly directed ramp 13 formed from the partial surfaces 14, 15 does not come into contact with this machine element if the cage 5 runs against a rotating or non-rotating machine element in an axial direction during operation of the roller screw drive 1.

The outer partial surface 15 extends from the end face 12 to a ring segment surface 17, the totality of all ring segment surfaces 17 being disposed in a plane which is spaced parallel from the end face 12. The ramp 13 and the ring segment surface 17 are located at the end of a longitudinal groove 18 which is formed in the ridge 9 on the inner circumferential surface of the cage 5.

The ring segment surface 17 is bordered by an impact surface 19 which merges seamlessly into a wall of the longitudinal groove 18 and is opposite the ramp 13 in a circumferential direction of the cage ring 8 and thus of the entire cage 5 borders. A groove extension 20 is formed in a portion of the longitudinal groove 18 which borders the groove base and is opposite the outer partial surface 15 and, like the longitudinal groove 18 as a whole, runs in an axial direction of the cage 5. This means that the longitudinal groove 18 has the largest width in a region bordering its groove base.

When the cage 5 rotates, lubricant located between the end face 12 of the cage 5 and another element, not shown, of the roller screw drive 1 is guided along the ramp 13 and thus directed in the direction of the impact surface 19. From there, the lubricant, namely grease, can enter the longitudinal groove 18 and thus not only be distributed in the cage 5, but also be fed to the rollers 4. In particular, the profiles 23 of the rollers 4 are wetted with lubricant so that it is distributed throughout the entire roller screw drive 1.

If, during operation of the roller screw drive 1, axial movements of the cage 5 occur relative to surrounding elements, including a housing of the roller screw drive 1, the lubricant-conveying contours 11 with the adjoining longitudinal grooves 8 contribute to the displacement of lubricant located at the end face 12 from the end-face region. Each lubricant-conveying contour 11 has an effect according to the direction of rotation. In FIG. 1, two lubricant-conveying contours 11 can be seen in the upper region of the cage 5, which are incorporated into the cage ring 8. As can be seen from FIG. 1, the left lubricant-conveying contour 11 in this arrangement is mirror-symmetrical with respect to the right lubricant-conveying contour 11 in the same arrangement. This achieves a lubricant-conveying effect which is just as great when the cage 5 rotates clockwise as it is when the cage 5 rotates counterclockwise.

In the exemplary embodiment, there are two pairs of lubricant-conveying contours 11 that are mirror-symmetrical with respect to one another. Likewise, a lubricant-conveying contour 11 and an associated longitudinal groove 18 extending through the entire cage ridge 9 could be formed on each of the six cage ridges 9 in the present case.

In a manner not shown, ramps 13, each of which opens into a longitudinal groove 18, can also be present on the opposite end face 12 of the cage 5, which is not visible in FIG. 1. The ramps 13 on the opposite end faces 12 are designed in such a way that, when the cage 5 rotates clockwise, lubricant is conveyed in a defined axial direction through the longitudinal groove 18, whereas when the cage 5 rotates counterclockwise, the lubricant is conveyed in the opposite axial direction.

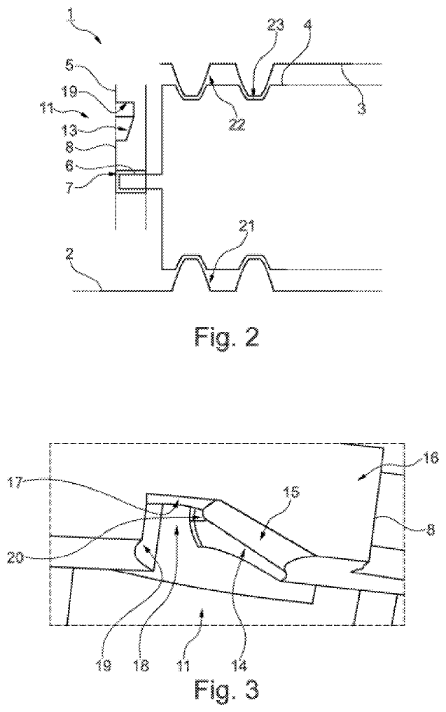

The cage 5 according to FIG. 4 is also suitable for installation in a roller screw drive 1 as illustrated in FIG. 2. In this case, there are various contours 24, 25 which interrupt the ridges 9, i.e., cage ridges, and/or the longitudinal grooves 18 approximately centrally between the two end faces 12 of the cage 5 and have the function of conveying lubricant in a radial direction of the cage 5 and thus of the entire roller screw drive 1.

The reference sign 24 denotes short radial ridges which represent a barrier within the longitudinal groove 18. Lubricant flowing axially, i.e., in the longitudinal direction of the groove 18, through the longitudinal groove 18 is stopped by the radial ridge 24 and directed towards the central axis of the roller screw drive 1, i.e., the threaded spindle 2.

Conversely, the bores 25 which run obliquely from the base of the longitudinal groove 18 to the circumferential surface 16 ensure that lubricant flowing in the longitudinal groove 18 is directed to the outside of the cage 5, i.e., in the direction of the nut ring 3.

In the design shown in FIG. 4, both radial ridges 24 and bores 25 exist as means that impart a radially directed movement component to flowing lubricant. The different contours 24, 25 are located on one and the same ridge 9 of the cage 5. Deviating from this, designs can also be realized in which at least one ridge 9 is provided exclusively with a radial ridge 24 located on its inner side and at least one additional ridge 9 is provided exclusively with bores 25. For example, half of the longitudinal grooves 18 of the cage 5 are interrupted by short radial ridges 24, while the other half of the longitudinal grooves 18 of the same cage 5 are each connected to the outer circumferential surface 16 of the cage by bores 25. Further possible variants of the cage 5 have either exclusively radial ridges 24 or exclusively bores 25, in each case as means for directing a lubricant flow. In all cases, the cage 5 contributes significantly to the uniform lubricant supply both to the contacts between the rollers 4 and the threaded spindle 2 and to the contacts between the rollers 4 and the nut ring 3.

### LIST OF REFERENCE SIGNS

1 Roller screw drive
2 Threaded spindle
3 Nut, nut ring
4 Roller, rolling body
5 Cage
6 Roller pin
7 Recess in the cage for roller pin
8 Cage ring
9 Cage ridge, ridge
10 Pocket
11 Lubricant-conveying contour
12 End face of the cage
13 Ramp
14 Inner partial surface of the ramp
15 Outer partial surface of the ramp
16 Circumferential surface
17 Ring segment surface
18 Longitudinal groove
19 Impact surface
20 Groove extension
21 Thread of the spindle
22 Thread of the nut
23 Profile of the roller
24 Radial ridge
25 Bore

1. A roller screw drive comprising:
a cage having an end face and a plurality of pockets;
a plurality of rolling bodies guided by the cage;
lubricant-conveying contours formed at the end face of the cage, wherein each of the lubricant-conveying contours is adjoined by a longitudinal groove which is located in a ridge separating two pockets of the cage from each other; and
a rolling body received by the two pockets.

2. The roller screw drive according to claim 1, wherein the longitudinal groove is located on the inner circumferential surface of the cage.

3. The roller screw drive according to claim 2, wherein the lubricant-conveying contours are each formed by a ramp starting from the end face of the cage and extending to the longitudinal groove, and an impact surface arranged on the side of the longitudinal groove opposite the ramp and oriented at least approximately at a right angle to the end face.

4. The roller screw drive according to claim 3, wherein the ramp has a first partial surface bordering the inner circumferential surface of the cage and a second partial surface bordering the outer circumferential surface of the cage, the second partial surface being positioned at least partially steeper than the first partial surface relative to the end face of the cage.

5. The roller screw drive according to claim 4, wherein the longitudinal groove has a groove extension which borders a groove base, that extends from the second partial surface in a longitudinal direction of the groove.

6. The roller screw drive according to claim 1, wherein two circumferentially adjacent lubricant-conveying contours are designed mirror-symmetrical with respect to one another, the number of lubricant-conveying contours arranged on one and the same end face being less than the number of the plurality of pockets of the cage.

7. The roller screw drive according to claim 1, wherein the roller screw drive is designed as a planetary roller screw drive, which has a threaded spindle an associated nut and rollers having pitchless profiles as rolling bodies which roll between the threaded spindle and the nut, one of the two elements of threaded spindle and nut being provided as a drive element.

8. The roller screw drive according to claim 1, wherein the roller screw drive is designed as a planetary roller screw drive which has a threaded spindle, an associated nut and rollers having pitchless profiles as rolling bodies which roll between the threaded spindle and the nut, the cage being provided as a drive element.

9. The roller screw drive according to claim 1, wherein the roller screw drive is designed as a threaded roller screw drive, the rollers of which, as well as its nut ring and threaded spindle, have a pitched profile.

10. The roller screw drive according to claim 9, wherein the at least one of the ridge and the longitudinal groove running therein is interrupted by at least one contour which is designed to conduct lubricant in a radial direction of the cage.

11. A roller screw drive comprising:
a cage having an end face and a plurality of pockets;
a plurality of rolling bodies guided by the cage;
lubricant-conveying contours formed at the end face of the cage, wherein each of the lubricant-conveying contours is adjoined by a longitudinal groove which is located in a ridge separating two pockets of the cage from each other, wherein the lubricant-conveying contours are each formed by a ramp starting from the end face of the cage and extending to the longitudinal groove, and an impact surface arranged on the side of the longitudinal groove opposite the ramp and oriented at least approximately at a right angle to the end face, and wherein the ramp has a first partial surface bordering the inner circumferential surface of the cage and a second partial surface bordering the outer circumferential surface of the cage, the second partial surface being positioned at least partially steeper than the first partial surface relative to the end face of the cage; and
a rolling body received by the two pockets.

12. The roller screw drive according to claim 11, wherein the longitudinal groove is located on the inner circumferential surface of the cage.

13. The roller screw drive according to claim 12, wherein the longitudinal groove has a groove extension which borders a groove base that extends from the second partial surface in a longitudinal direction of the groove.

14. The roller screw drive according to claim 11, wherein two circumferentially adjacent lubricant-conveying contours are designed mirror-symmetrical with respect to one another, the number of lubricant-conveying contours arranged on one and the same end face being less than the number of the plurality of pockets of the cage.

15. The roller screw drive according to claim 11, wherein the roller screw drive is designed as a planetary roller screw drive, which has a threaded spindle, an associated nut and rollers having pitchless profiles as rolling bodies which roll between the threaded spindle and the nut, one of the two elements of threaded spindle and nut being provided as a drive element.

16. The roller screw drive according to claim 11, wherein the roller screw drive is designed as a planetary roller screw drive which has a threaded spindle, an associated nut and rollers having pitchless profiles as rolling bodies which roll between the threaded spindle and the nut, the cage being provided as a drive element.
